(19) United States
(12) Patent Application Publication
(10) Pub. No.: US 2012/0154421 A1
(43) Pub. Date: Jun. 21, 2012

(54) Image Display Apparatus

(76) Inventor: Masaki TSUCHIDA, Tokyo (JP)

(21) Appl. No.: 13/166,712

(22) Filed: Jun. 22, 2011

(30) Foreign Application Priority Data
Dec. 20, 2010 (JP) 2010-283336

(51) Int. Cl. G09G 5/02

(52) U.S. Cl. 345/589

(57) ABSTRACT

According to an embodiment, there is provided an image display apparatus in which a display pixel displaying an image comprises a plurality of parallax image pixels respectively displaying a plurality of parallax images. The image display apparatus includes: an intermediate gradation level processing unit configured to prepare an intermediate gradation level generation pattern every parallax image to generate an intermediate gradation level with respect to an image signal including a plurality of parallax images, and perform processing of adding an intermediate gradation level to each of the parallax images by using the intermediate gradation level generation pattern and the image signal; and an image display unit configured to display the parallax images each having an intermediate gradation level added by the intermediate gradation level processing unit.

### CROSS-REFERENCE TO RELATED APPLICATION

This application is based upon and claims the benefit of priority from prior Japanese Patent Application No. 2010-283336 filed on Dec. 20, 2010 in Japan, the entire contents of which are incorporated herein by reference.

### FIELD

Embodiments described herein relate generally to an image display apparatus.

### BACKGROUND

In general, in an image display apparatus such as a liquid crystal apparatus, gradation levels which can be represented are limited. If a video such as a ramp signal is displayed, therefore, a ramp signal having differences in level is obtained, resulting in a video which lacks smoothness. Therefore, it is known to represent a smooth video by using a method (Frame Rate Control (FRC)) scheme and a dither method) for artificially increasing the gradation levels in terms of space and time.

If the above-described FRC scheme and the dither method are applied as they are to an image display apparatus (for example, an autostereoscopic image display apparatus) in which one display pixel displaying an image is formed of a set of a plurality of parallax image pixels displaying a plurality of parallax images (multiple parallax images), then it is feared that the picture quality will be degraded because parallax image signals displayed on two parallax image pixels which are in contact with a boundary between adjacent display pixels are in general image signals of different parallaxes.

### BRIEF DESCRIPTION OF THE DRAWINGS

FIG. 1 is a block diagram showing an image display apparatus according to a first embodiment;

FIG. 2 is a diagram showing a display screen of an image display unit according to the first embodiment;

FIG. 3 is a diagram showing one specific example of an intermediate gradation level generation pattern;

FIGS. 4(a) to 4(c) are diagrams for explaining a method for using an intermediate gradation level generation pattern;

FIGS. 5(a) to 5(d) are diagrams for explaining a method for generating an intermediate gradation level in the image display apparatus according to the first embodiment; and

FIGS. 6(a) to 6(c) are diagrams for explaining a method for generating an intermediate gradation level in the image display apparatus according to a second embodiment.

### DETAILED DESCRIPTION

According to an embodiment, there is provided an image display apparatus in which a display pixel displaying an image comprises a plurality of parallax image pixels respectively displaying a plurality of parallax images. The image display apparatus includes: an intermediate gradation level processing unit configured to prepare an intermediate gradation level generation pattern every parallax image to generate an intermediate gradation level with respect to an image signal including a plurality of parallax images, and perform processing of adding an intermediate gradation level to each of the parallax images by using the intermediate gradation level generation pattern and the image signal; and an image display unit configured to display the parallax images each having an intermediate gradation level added by the intermediate gradation level processing unit.

Hereafter, an image display apparatus according to the embodiments will be described more specifically with reference to the drawings.

### First Embodiment

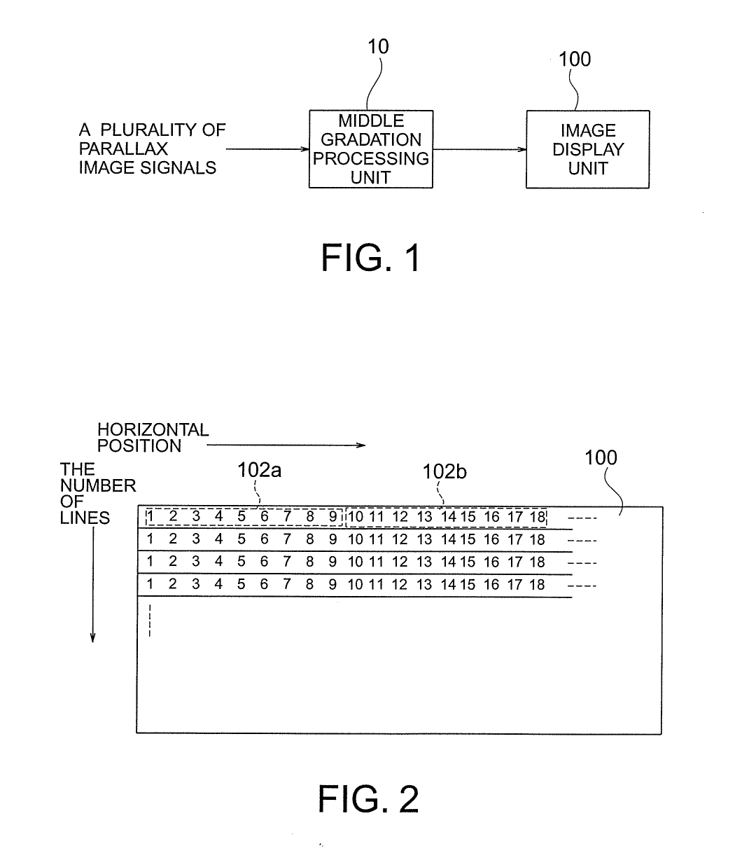

An image display apparatus according to a first embodiment is shown in FIG. 1. The image display apparatus according to the first embodiment includes an intermediate gradation level processing unit 10 and an image display unit 100. The intermediate gradation level processing unit 10 receives an image signal including a plurality of parallax image signals as its input, and generates and gives an intermediate gradation level of an image signal for each frame by regarding sixteen consecutive frames (first to sixteenth frames) concerning the image signal as one set and using the image signal and an intermediate gradation level generation pattern (for example, a four by four intermediate gradation level generation pattern). And the image display unit 100 displays an image by using image signals of the first to sixteenth frames provided with intermediate gradation levels.

In the image display unit 100, display pixels each of which display a plurality of parallax images (nine parallax images in FIG. 2) as one set in the horizontal direction are disposed in parallel. Therefore, the display pixel is formed of nine parallax image pixels which display parallax images. In FIG. 2, each of a display pixel 102a in a first row and a display pixel 102b located on the right side of and adjacent to the display pixel 102a has nine parallax image pixels. And a parallax image displayed by a leftmost parallax image pixel (denoted by a numeral 10) in the display pixel 102b becomes the same image as a parallax image displayed by a leftmost parallax image pixel (denoted by a numeral 1) in the display pixel 102a. In other words, if each display pixel is formed of nine parallax image pixels and parallax image pixels arranged in the horizontal direction on a display face of the image display unit 100 are provided with numbers in order from the left as shown in FIG. 2, parallax image pixels provided with numbers 9m+i (where m is an integer of at least 0, and i is an integer in the range of 1 to 8 both inclusive) display the same parallax image. Note that it is supposed in the present embodiment that parallax images have parallax in the horizontal direction and have no parallax in the vertical direction.

Furthermore, if all parallax images in one display pixel are the same, video display having it as one pixel unit is performed.

Furthermore, an autostereoscopic image display apparatus (without glasses) is obtained by disposing an optical system in a position corresponding to each display pixel of the image display unit 100 according to the present embodiment.

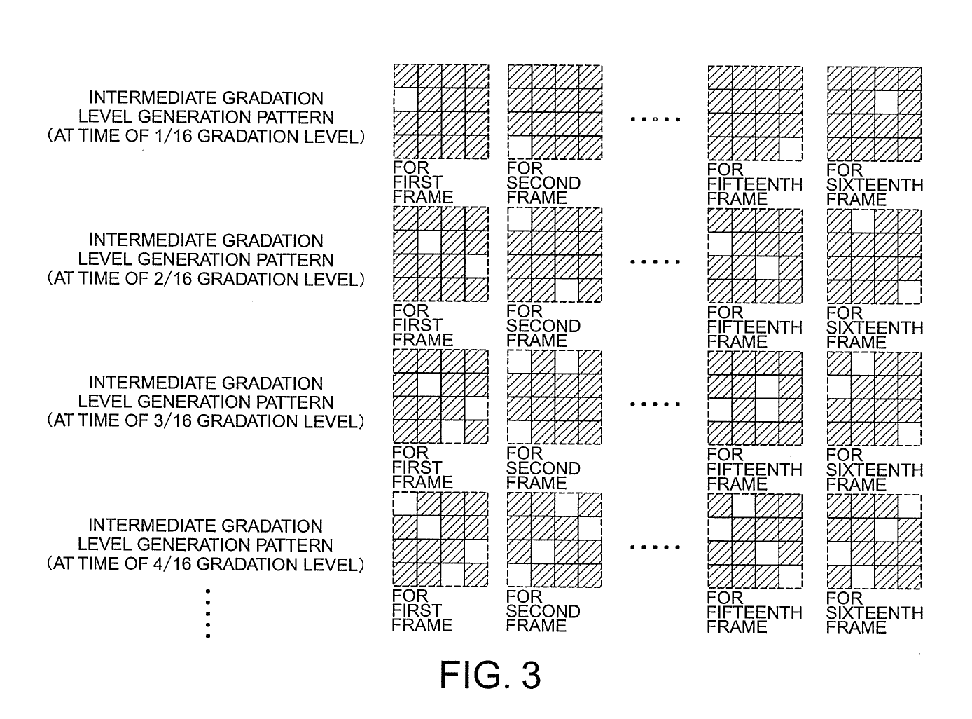

Specific examples of the intermediate gradation level generation patterns used in the image display apparatus according to the present embodiment are shown in FIG. 3. This intermediate gradation level generation patterns are intermediate gradation level generation patterns represented by a four by four matrix, and have patterns which generates intermediate gradation levels of sixteen kinds, i.e., a 1/16 gradation level to a 16/16 gradation level respectively for the first to sixteenth frames. In the intermediate gradation level generation patterns shown in FIG. 3, a shaded square (referred to as element as well) has a value (referred to as element value as well) of “0” and a non-shaded square (element) has an element value of “1.” For example, intermediate gradation level generation patterns in the first row shown in FIG. 3 are patterns which provide the first to sixteenth frames with a 1/16 gradation level. In the intermediate gradation level generation pattern for the first frame which provides the 1/16 gradation level, an element value in the first column of the second row is “1” and other element values are “0.” In all of the sixteen intermediate gradation level generation patterns in the first row shown in FIG. 3, the position of the element having the element value of “1” is different. Furthermore, intermediate gradation level generation patterns in the second row in FIG. 3 are patterns which provide the first to sixteenth frames with a 2/16 gradation level. In each of the intermediate gradation level generation patterns in the second row, two element values are “1” and other element values are “0.” And in the sixteen intermediate gradation level generation patterns which provide the 2/16 gradation level, disposition positions of two elements having an element value of “1” are different. In addition, in elements in the same position of the sixteen intermediate gradation level generation patterns, the number of elements having an element value “1” is two. In the same way, in each of intermediate gradation level generation patterns which provide a i/16 gradation level (where i is an arbitrary integer in the range of 1 to 15), i elements out of 16 elements have an element value of “1” and other elements have an element value of “0.” In intermediate gradation level generation patterns for the first to sixteenth frames, disposition of i elements having an element value “1” is different. In addition, in elements in the same position of the sixteen intermediate gradation level generation patterns, the number of elements having an element value “1” is i. Although not illustrated, in each of intermediate gradation level generation patterns which provide a 16/16 gradation level, all elements have an element value “0.” Note that intermediate gradation level generation patterns used for the first to sixteenth frames are not restricted to the patterns shown in FIG. 3, but patterns which provide the same gradation level can be interchanged among the first to sixteenth frames.

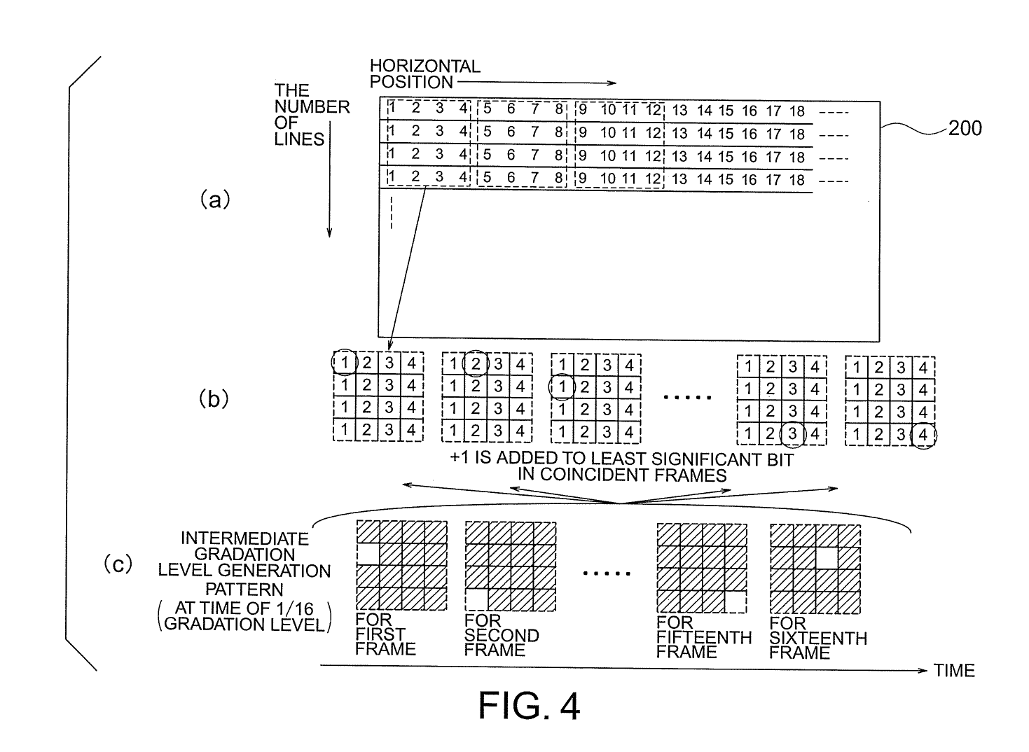

A method for using the intermediate gradation level generation patterns will now be described by taking an image display unit 200 which displays an image in which one pixel is represented by one image signal as an example with reference to FIGS. 4(a) to 4(c). As shown in FIG. 4(a), the image display unit 200 is an ordinary display panel such as a full HD (High Definition) display panel, on which pixels are arranged in order every line.

And as shown in FIG. 4(b), the pattern which provides an intermediate gradation level is changed in terms of space and time by taking four by four pixels which are consecutive longitudinally and laterally as the unit. As the pattern which provides this intermediate gradation level, for example, the intermediate gradation level generation pattern shown in FIG. 3 is used. FIG. 4(b) is a diagram showing four by four pixels in the first to four rows by the first to fourth columns on the image display unit 200. FIG. 4(b) shows on which out of the four by four pixels an image signal which is successively input to the image display apparatus is displayed. A position of a pixel on which the input image signal is displayed is indicated by surrounding a numeral with a circle. For example, in leftmost four by four pixels shown in FIG. 4(b), a numeral “1” of a pixel in the first row and the first column is surrounded by a circle, which indicates that an image signal to be displayed on a pixel in this position has been input.

FIG. 4(c) shows intermediate gradation level generation patterns which provide the first to sixteenth frames with the 1/16 gradation level. The intermediate gradation level generation patterns are the same patterns as the intermediate gradation level generation patterns which provide the first to sixteenth frames with the 1/16 gradation level shown in FIG. 3.

A method for generating intermediate gradation levels in the image display apparatus having the image display unit 200 shown in FIG. 4(a) will now be described.

First, sixteen by sixteen intermediate gradation level generation patterns as shown in, for example, FIG. 3 which provide the first to sixteenth consecutive frames with intermediate gradation levels of 16 kinds, i.e., the 1/16 gradation level to 16/16 gradation level are prepared and stored in a memory.

Upon being supplied with image signals of the first to sixteenth consecutive frames, the image display apparatus generates intermediate gradation levels by taking four by four pixels as the unit respectively for the first to sixteenth frames as described heretofore. Note that it is supposed that corresponding pixels have the same pixel value in the first to sixteenth frames.

In each frame, the position of a display pixel which displays an input image signal, i.e., the position corresponding to the above-described display pixel in the four by four pixels is determined. In addition, sixteen intermediate gradation level generation patterns which provide the first to sixteenth frames with the i/16 gradation level are read out from the memory, where i is a decimal number represented by four low-order bits in the image signal. Subsequently, with respect to a pixel of each of the first to sixteenth frames corresponding to the display pixel, modification of adding “1” as the least significant bit of a pixel value of the pixel of the frame is performed when the corresponding element value of the intermediate gradation level generation pattern which is read out is “1” and modification of adding “0” as the least significant bit of a pixel value of the pixel of the frame is performed when the corresponding element value is “0.” Note that the adding “0” as the least significant bit of the pixel value means that any modification is not performed on the pixel value. In this way, modification for increasing gradation levels is performed on pixel values of the first to sixteenth frames. Subsequently, the image display unit 200 displays an image by using the modified first to sixteenth frames.

For example, it is supposed that the display pixel which displays an input image signal is a pixel in the second row of the first column in the image display unit 200 and four low-order bits of the image signal is “0001” (which is a decimal number “1”). Thereupon, the position of the display element in the four by four pixels is determined to be in the first column of the second row (FIG. 4(b)). In addition, sixteen intermediate gradation level generation patterns which provide the 1/16 gradation level shown in FIG. 4(c) are read out from the memory. And as FIG. 4(c), the element of an intermediate gradation level generation pattern used in the first frame which corresponds to the position of the display pixel becomes “1” in element value and the element of an intermediate gradation level generation pattern used in each of other frames which corresponds to the position of the display pixel becomes “0” in element value. As a result, modification of adding “1” as the least significant bit of the pixel value of the pixel in the first frame corresponding to the display pixel is performed, and any modification is not performed on the pixel value of the pixel in each of the second to sixteenth frames corresponding to the display pixel. If the image display unit 200 displays the display pixel by using the first to sixteenth frames thus modified, the display pixel is displayed once in the first to sixteenth frames. If the sixteen frames are averaged, therefore, it is equivalent to displaying the display pixel with the gradation level of 1/16.

However, the above described method for generating the intermediate gradation levels in the order of the input images cannot be applied to the image display apparatus according to the first embodiment. The reason will now be described. In the image display apparatus according to the first embodiment, a display pixel is formed of a set of parallax image pixels which display a plurality of parallax images (in FIG. 2, nine parallax images) as shown in FIG. 2. In general, parallax image pixels in contact with a boundary between display pixels which are adjacent to each other display different parallax images. If intermediate gradation levels are generated by using the above-described method, therefore, there is a possibility that the gradation levels will decrease and the picture quality will be degraded.

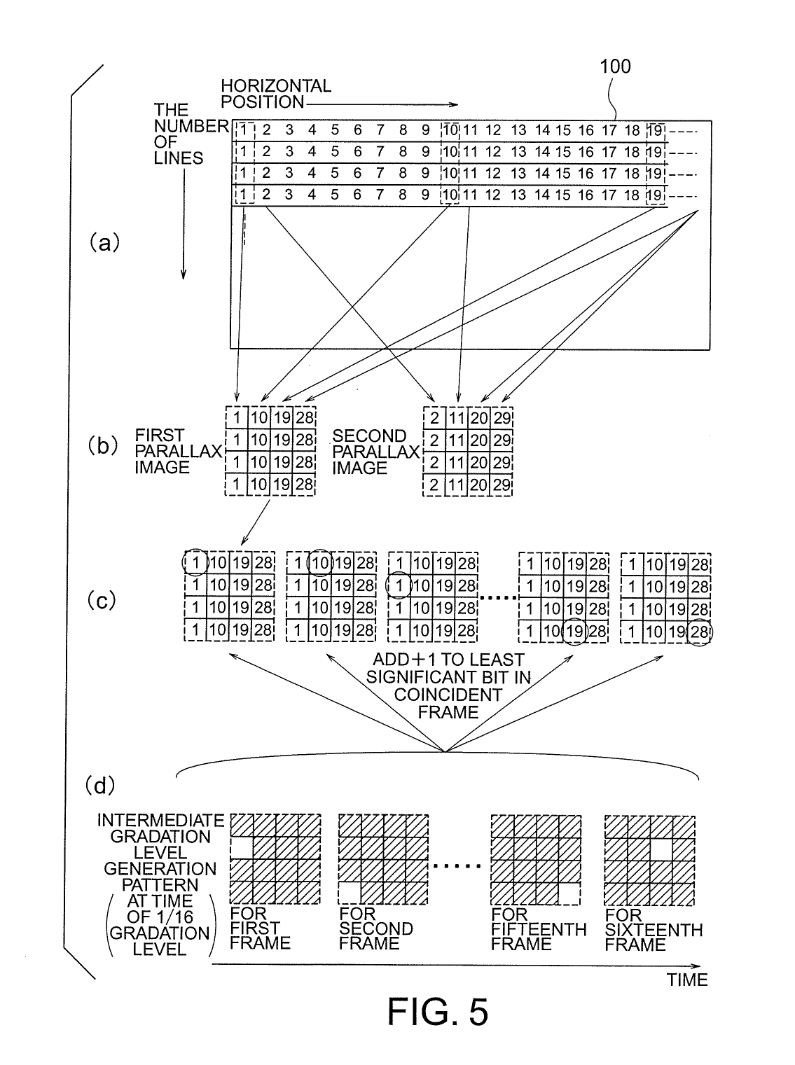

In the first embodiment, therefore, consecutive pixels are not used as the pixels which form the four by four pixels unlike the case described with reference to FIGS. 4(a) to 4(c), but processing is performed by using parallax image pixels which display the same parallax image as shown in FIGS. 5(a) and (b). For example, the four by four pixels of the first parallax image are formed of the first, tenth, nineteenth and twenty-eighth parallax image pixels on the display face of the image display unit 100, and processing is performed. The same is true of other parallax images as well.

A method for generating intermediate gradation levels in the image display apparatus according to the first embodiment will be described now. This intermediate gradation level generation processing is performed in the intermediate gradation level processing unit 10 shown in FIG. 1.

First, intermediate gradation level generation patterns as shown in, for example, FIG. 3 which provide the first to sixteenth consecutive frames with intermediate gradation levels of 16 kinds (1/16 gradation level to 16/16 gradation level) are prepared for each parallax image and stored in a memory. In other words, sixteen by sixteen intermediate gradation level generation patterns are prepared for each parallax image and stored in the memory.

This memory is included in the image display apparatus. However, the memory may be included in the intermediate gradation level processing unit 10.

Upon being supplied with image signals corresponding to sixteen consecutive frames, i.e., image signals of the first to sixteenth frames, corresponding parallax image pixels in the first to sixteenth frames have the same pixel value at this time. With respect to the first to sixteenth frames, intermediate gradation levels are generated every the same parallax image by taking four by four pixels formed of parallax image pixels which display the same parallax image as the unit, as described hereafter.

The position of a parallax image pixel (hereafter referred to as display pixel as well) which displays an input parallax image signal, i.e., the position corresponding to the above-described display pixel in the four by four pixels is determined. In addition, sixteen intermediate gradation level generation patterns which provide the first to sixteenth frames with the i/16 gradation level are read out from the memory, where i is a decimal number represented by four low-order bits in the parallax image signal. Subsequently, with respect to a parallax image pixel of each of the first to sixteenth frames corresponding to the display pixel, modification of adding “1” as the least significant bit of a pixel value of the parallax image pixel of the frame is performed when the corresponding element value of the intermediate gradation level generation pattern which is read out is “1” and modification of adding “0” as the least significant bit of a pixel value of the parallax image pixel of the frame is performed when the corresponding element value is “0.” Note that the adding “0” as the least significant bit of the pixel value means that any modification is not performed on the pixel value. This processing of providing the intermediate gradation levels is performed on parallax image pixels which display the same parallax image, by taking the four by four pixels as the unit. In addition, the processing is performed on all parallax images by using intermediate gradation level generation patterns prepared for respective parallax images. In other words, in the present embodiment, processing is performed with gradation levels increased every parallax image.

As a result, modification for increasing gradation levels is performed on pixel values of the parallax image pixels in the first to sixteenth frames. Subsequently, the image display unit 200 displays an image by using the modified first to sixteenth frames.

For example, it is supposed that the display pixel which displays an input first parallax image signal is a pixel in the second row of the first column in the image display unit 100 and four low-order bits of the first parallax image signal is “0001” (which is a decimal number “1”). Thereupon, the position of the display element in the four by four pixels is determined to be in the first column of the second row (FIG. 5(c)). In addition, sixteen intermediate gradation level generation patterns which provide the 1/16 gradation level shown in FIG. 5(d) are read out from the memory. And as appreciated from FIG. 5(d), the element of an intermediate gradation level generation pattern used in the first frame which corresponds to the position of the display pixel becomes “1” in element value and the element of an intermediate gradation level generation pattern used in each of other frames which corresponds to the position of the display pixel becomes “0” in element value. As a result, modification of adding “1” as the least significant bit of the pixel value of the parallax image pixel in the first frame corresponding to the display pixel is performed, and any modification is not performed on the pixel value of the parallax image pixel in each of the second to sixteenth frames corresponding to the display pixel. If the image display unit 100 performs display by using the first to sixteenth frames thus modified, the display pixel is displayed once in the first to sixteenth frames. If the first to sixteen frames are averaged, therefore, it is equivalent to display with the gradation level of 1/16.

According to the present embodiment, it is possible to prevent the picture quality from being degraded even if each of display pixels which display an image is formed of a plurality of parallax image pixels which display a plurality of parallax images, as described heretofore.

Note that the intermediate gradation level generation processing may be implemented by using hardware or may be implemented by using software. In addition, although sixteen gradation levels are implemented by using the sixteen frames, another number of gradation levels may be implemented by using a similar method. For example, four gradation levels using four frames may be implemented by using two low-order bits of the parallax image signal.

Furthermore, the first embodiment can be applied to both a still picture and a moving picture. If the first embodiment is applied to a moving picture, then it is desirable to apply the first embodiment to a standstill region of the moving picture.

### Second Embodiment

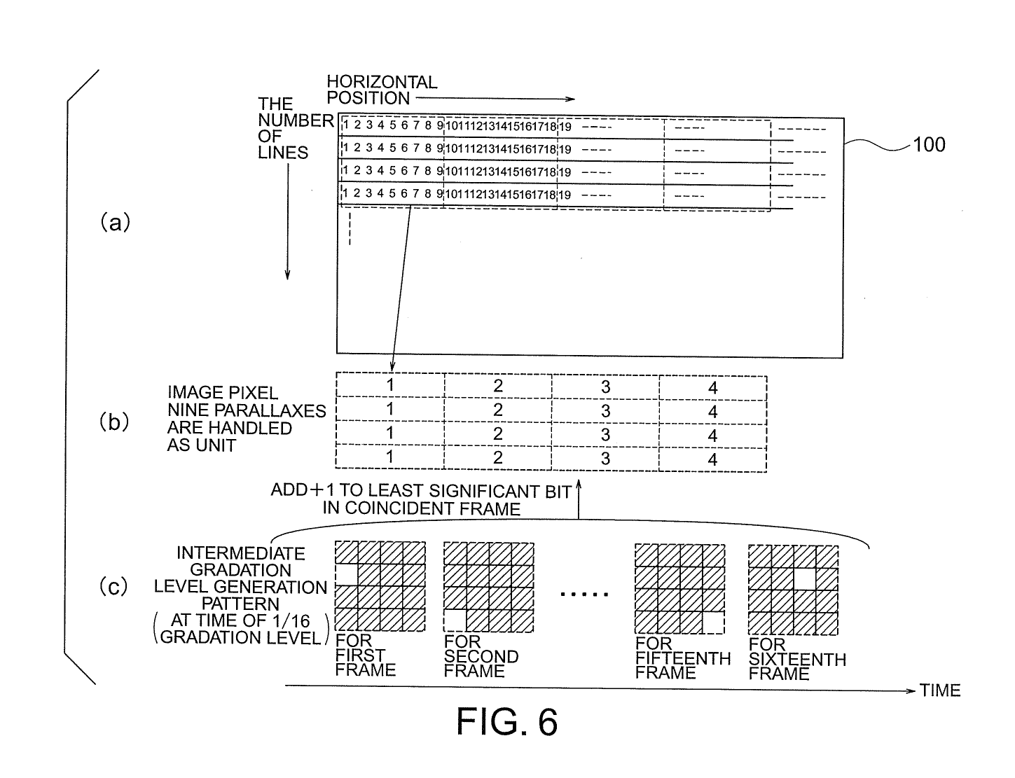

An image display apparatus according to a second embodiment will now be described with reference to FIGS. 6(a) to 6(c). The image display apparatus according to the second embodiment differs from the image display apparatus according to the first embodiment shown in FIG. 1 in the configuration of the four by four pixels which becomes the unit of the intermediate gradation level processing. As shown in FIG. 6(a), for example, nine parallax image pixels are handled as one display pixel. As shown in FIG. 6(b), intermediate gradation level generation processing is performed by handling nine parallax image pixels as one pixel included in the four by four pixels which becomes the unit of the intermediate gradation level processing. In other words, nine parallax image pixels in the first row of the first to ninth columns in the image display unit 100 are processed as a pixel in the first row of the first column in the four by four pixels. Nine parallax image pixels in the first row of the tenth to eighteenth columns in the image display unit 100 are processed as a pixel in the first row of the second column in the four by four pixels. This is used when all of the nine parallax image signals are the same image signal. In other words, it is used when displaying a two-dimensional image in an image display apparatus capable of displaying a two-dimensional image and a three-dimensional image.

Intermediate gradation level processing in the second embodiment is performed

First, sixteen by sixteen intermediate gradation level generation patterns as shown in, for example, FIG. 3 which provide the first to sixteenth consecutive frames with intermediate gradation levels of 16 kinds (the 1/16 gradation level to 16/16 gradation level) are prepared and stored in a memory.

Subsequently, the position of a display pixel which displays an input image signal, i.e., the position corresponding to the above-described display pixel in the four by four pixels is determined. In addition, sixteen intermediate gradation level generation patterns which provide the first to sixteenth frames with the i/16 gradation level are read out from the memory, where i is a decimal number represented by four low-order bits in the parallax image signal. Note that in the present embodiment, all of nine parallax image signals displayed by nine parallax image pixels corresponding to one pixel in the four by four pixels are the same parallax image signal. Therefore, the nine parallax image signals have the same value in four low-order bits.

Subsequently, with respect to a parallax image pixel of each of the first to sixteenth frames corresponding to the display pixel, modification of adding “1” as the least significant bit of a pixel value of the parallax image pixel of the frame is performed when the corresponding element value of the intermediate gradation level generation pattern which is read out is “1” and modification of adding “0” as the least significant bit of a pixel value of the parallax image pixel of the frame is performed when the corresponding element value is “0.” Note that the adding “0” as the least significant bit of the pixel value means that any modification is not performed on the pixel value. Thus, modification for increasing gradation levels is performed on pixel values of the first to sixteenth frames. Subsequently, the image display unit 100 displays an image by using the modified first to sixteenth frames. Note that FIG. 6(c) is a diagram showing intermediate gradation level generation patterns used in the first to sixteenth frames when generating 1/16 gradation level.

The second embodiment becomes the same as the case where intermediate gradation levels are generated by using the same intermediate gradation level generation pattern for all parallax images in the first embodiment.

According to the second embodiment, it is possible to prevent the picture quality from being degraded even if each of display pixels which display an image is formed of a plurality of parallax image pixels which display a plurality of parallax images, as described heretofore.

In the second embodiment as well, sixteen gradation levels are implemented by using sixteen frames. However, another number of gradation levels may be implemented by using a similar method. For example, four gradation levels using four frames may be implemented by using two low-order bits of the parallax image signal.

Furthermore, the second embodiment can be applied to both a still picture and a moving picture. If the second embodiment is applied to a moving picture, then it is desirable to apply the second embodiment to a standstill region of the moving picture.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An image display apparatus in which a display pixel displaying an image comprises a plurality of parallax image pixels respectively displaying a plurality of parallax images, the image display apparatus comprising:
an intermediate gradation level processing unit configured to prepare an intermediate gradation level generation pattern every parallax image to generate an intermediate gradation level with respect to an image signal including a plurality of parallax images, and perform processing of adding an intermediate gradation level to each of the parallax images by using the intermediate gradation level generation pattern and the image signal; and
an image display unit configured to display the parallax images each having an intermediate gradation level added by the intermediate gradation level processing unit.

2. The image display apparatus according to claim 1, wherein the intermediate gradation level processing unit provides each of a plurality of consecutive frames concerning the image signal with the intermediate gradation level generation pattern, and performs processing of adding an intermediate gradation level to each of the plurality of frames with respect to each of the parallax images.

3. The image display apparatus according to claim 1, wherein the processing of adding an intermediate gradation level is performed by using an identical intermediate gradation level generation pattern for the plurality of parallax images.

4. The image display apparatus according to claim 2, wherein the processing of adding an intermediate gradation level is performed by taking N by N parallax image pixels as a unit, where N is an integer of at least 2.

5. The image display apparatus according to claim 4, wherein
the intermediate gradation level generation pattern is an N by N matrix,
each of elements which form the matrix has a value of “1” or “0,” and
the intermediate gradation level generation patterns which provide an identical intermediate gradation level have an identical number of elements which are “1” in value.

6. The image display apparatus according to claim 5, wherein
the plurality of frames is N by N in number, and
the intermediate gradation level generation patterns which provide the frames with an identical intermediate gradation level differ in disposition of an element having a value of “1.”

7. The image display apparatus according to claim 6, wherein
the processing of adding an intermediate gradation level comprises:
selecting the intermediate gradation level generation patterns which provide an identical gradation level on the basis of a pixel value of the parallax image pixel in one of the plurality of frames, and associating the intermediate gradation level generation patterns with respective frames;
as for a parallax image pixel in arbitrary one frame out of the plurality of frames, responding to a value of an element corresponding to the parallax image pixel in an intermediate gradation level generation pattern corresponding to the frame being “1,” by performing modification of adding “1” to a least significant bit of the pixel value of the parallax image pixel; and
responding to the value of the element corresponding to the parallax image pixel in the intermediate gradation level generation pattern corresponding to the frame being “0,” by performing no modification on the pixel value of the parallax image pixel.

8. The image display apparatus according to claim 4, wherein the processing of adding an intermediate gradation level is performed by taking 4 by 4 parallax image pixels as a unit.
